(19) United States
(12) Patent Application Publication
(10) Pub. No.: US 2007/0136226 A1
(43) Pub. Date: Jun. 14, 2007

(54) JDF PACKAGE MANAGEMENT METHOD

(75) Inventor: Christopher Lee Irick, Rochester, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/275,140

(22) Filed: Dec. 14, 2005

(51) Int. Cl. G06F 17/30

(52) U.S. Cl. 707/1

(57) ABSTRACT

A method of managing incoming files in a work environment that includes receiving at least one incoming file, extracting and storing in memory at least one of a ticket and a content file from the incoming file, reading the ticket extracted from the incoming file, updating a path to the content file on the basis of the read ticket, updating the ticket with data form the work environment, storing the updated path to the content file in a memory, and submitting the updated ticket to a work flow.

### BACKGROUND

Creative content files such as, for example, Acrobat 7 Pro JDF MIME file packages, generally consist of PDF files and JDF tickets that contain relative file paths. The JDF ticket references a content file, such as a PDF file, that is located in a subfolder, as described in, for example, “JDF Specification”, International Cooperation for the Integration of Processes in Prepress, Press and Postpress, 2004. In conventional MIME packages with known naming conventions of both JDF tickets and PDF files, managing is relatively easy.

### SUMMARY

However, problems may arise when a user attempts to manage incoming JDF MIME packages from different customer sources with, for example, hand-written JDF files that do not have the same naming conventions as conventional MIME packages. For example, confusion may arise because Adobe has a predefined naming convention when creating JDF packages, different customers may create different JDF files with different source files that have the exact same naming convention. Also, the hierarchical method of extraction and using relative paths may prevent printers from using the files in certain production scenarios if the relative paths are not regularly updated.

An example of a production limitation is that relative file paths within the JDF may not be supported by applications trying to parse them. Moreover, customer service representatives who are operators in a workshop need the ability to perform in an automated fashion the extraction of the contents of a JDF MIME package into directories of the operator's choosing. The operator needs the ability to define where the production content files should be placed and where the tickets should be stored. The JDF ticket should have all production file references updated automatically based on where they are placed. The original MIME file should be archived automatically as well.

A problem may also arise when attempting to extract or automatically manage JDF MIME packages manually submitted to a workflow that contains FreeFlow products. The MIME packages contain job tickets and production print files that cannot be easily extracted in a way that can be used. Each product has unique requirements for submission of these tickets and how those tickets reference their production files.

Various exemplary embodiments of the systems and methods according to this invention provide a method of managing incoming files in a work environment that includes receiving at least one incoming file, extracting and storing in memory at least one of a ticket and a content file from the incoming file, reading the ticket extracted from the incoming file, updating a path to the content file on the basis of the read ticket, updating the ticket with data form the work environment, storing the updated path to the content file in a memory, and submitting the updated ticket to a work flow.

### BRIEF DESCRIPTION OF EMBODIMENTS

Various exemplary embodiments of the systems and methods will be described in detail, with reference to the following figures, wherein:

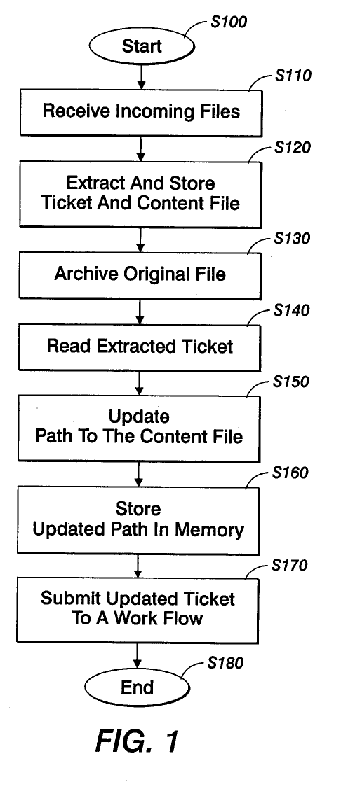

FIG. 1 is a flow chart representing an illustration of an exemplary method of managing incoming files in a work environment; and

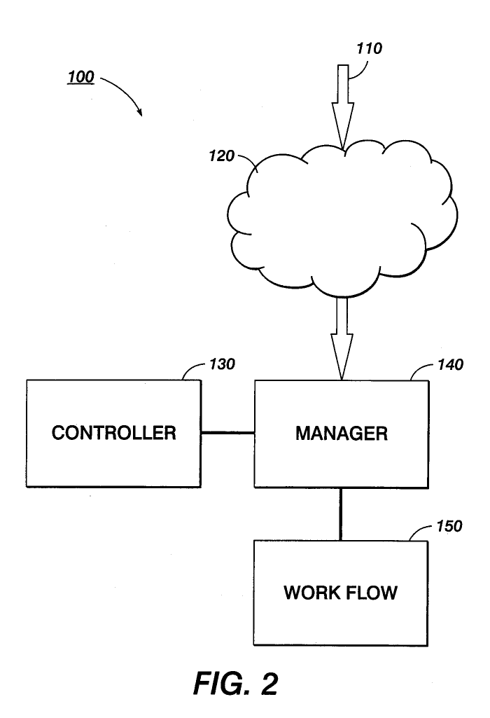

FIG. 2 is a diagram illustrating an exemplary system for managing incoming files in a work environment.

### DETAILED DESCRIPTION OF EMBODIMENTS

These and other features and advantages are described in, or are apparent from, the following detailed description of various exemplary embodiments of the systems and methods:

FIG. 1 is a flow chart representing an illustration of an exemplary method of managing incoming files in a work environment. In FIG. 1, the method starts in step S100, and continues to step S110, where an incoming file such as, for example, a MIME package or a zip file, is received in the work environment. According to various exemplary embodiments, the incoming file is submitted via a protocol and through a server, via email, FTP, a network, or the like, and includes one or more MIME packages. These packages may also be stored in regularly polled environments such as, for example, a network server location or other locations. These locations are polled for content regularly. Polling may be performed either by a user of automatically, and the frequency of polling may be determined either by a user or automatically. Also, a new folder may be created based on the project name and unique ID. According to various exemplary embodiments, the incoming files may be created by a user and may be, example, home made by the user. These home made files may not correspond to conventional MIME packages, but the home made files may be subjected to the same treatment as conventional MIME packages. Next, control continues to step S120, during which both the ticket and the content of the file are extracted from the MIME package. For example, the ticket within the MIME package is a JDF file named “JDFProdDef.jdf”. According to various exemplary embodiments, a reference to the creative content file such as, for example, the PDF file, may be located in the JDF ticket. This reference to the creative content is conventionally named “filespecURL”. Next, control to continues to step S130 during which, according to various exemplary embodiments, the original MIME package is sent to a pre-defined archive folder. Thus, according to various exemplary embodiments, a new folder within the archive folder is created, and the new folder within the archive folder may also be based on the project name and a unique ID. Moreover, a log may be created with the unique name and the file transfer activity.

Next, control continues to step S140, during which the extracted ticket, for example, the JDF file, is read. Next, control continues to step S150, during which the ticket is updated based on the intended destination of the content file, in the workflow. For example, the JDF “filespecURL” is updated to reflect the intended destination of the PDF file in the workflow. According to various exemplary embodiments, the update of the JDF file may be performed by a user or automatically. Also, the original JDF file may also be archived. Next, control continues to step S160, during which the updated ticket is stored in memory. For example, the updated JDF file is sent to a pre-defined location, and may be named using a preferred convention that fits the needs of a user. It should be noted that the above-described steps allow the handling of both conventional MIME packages and home made files that would not be easy to handle via the use the use of conventional software specifically geared to handle MIME packages. Moreover, users may not have the necessary tools to create MIME packages, and thus may not be able to have their content files handled as described above. According to various exemplary embodiments, the location of the updated JDF file, of the MIME package, and of the PDF file, may be defined either by a user or automatically. Next, control continues to step S170, during which the ticket is also submitted to the workflow. Next, control continues to step S180, where the method ends.

Various exemplary embodiments have two different modes of interaction: manual and automated. The automated mode allows a user to define a Hot Folder, or a dedicated memory, with the following features: a directory to deposit the one or more PDF production files that were polled during, for example, step S110; a directory to deposit the JDF file after the JDF file is extracted during, for example, step S120; and a directory to archive the original JDF during, for example, step S140. According to various exemplary embodiments, when the original MIME package is polled, the information included in the JDF file is automatically read to extract the corresponding location of one or more creative content files such as, for example, a PDF file, extract the JDF, update the file reference paths automatically, and submit the JDF, as well as archive the JDF MIME with a unique name identifier in order to avoid any nomenclature conflicts. Such automatic sequence of steps may reduce processing time of, for example, the manual operations of extraction and storage of MIME packages and their content stored therein.

Performing these actions manually by a user may allow the user to select a JDF file, elicit a MIME extraction method that would prompt the user to manually select directories for the output and JDF files, and the JDF file reference paths would also be updated upon extraction. For example, a context menu may be provided to the user that will allow the user to perform the specific actions described above.

Accordingly, this method may be a direct enabler for customers using FreeFlow Products such as, for example, Print Manager and Process Manager. This method may allow users to package all their JDF-related content in a simple and consistent manner that would be easily managed and distributed in, for example, a print shop. The same JDF MIME package could be used seamlessly across multiple JDF-enabled products with different requirements. Thus, this method prevents errors caused by multiple customers using similar naming conventions of packages, tickets, or production files.

This method also provides the ability to automatically manage extractions of JDF tickets and productions file based on a customer's asset management processes. Thus, file reference paths may be automatically updated, and JDF tickets may be moved to other processes without human intervention.

This method also provides the ability to allow users to manage extractions of JDF tickets and productions file based on a customer's asset management processes. Thus, users may choose which path type they would like to use depending on the support provided by the destination JDF processor.

FIG. 2 is a diagram illustrating an exemplary system for managing incoming files in a work environment. In FIG. 2, incoming files 110 such as, according to various exemplary embodiments, MIME packages, zip files or home made files, are submitted to the file manager 140 via, for example, a network 120. The incoming files 110 are then handled by the file manager 140 under the control of the controller 130, and the file manager 140 performs various operations on the incoming files 110. According the various exemplary embodiments, the file manager 140 receives the incoming files 110, extracts a job ticket and a content file from each incoming file 110 and stores the ticket and the content file of the incoming file in a memory. Moreover, the file manager 140 may also read the job ticket extracted from each incoming file 110, update a path to the content file extracted from each incoming file 110 on the basis of the job ticket extracted from each incoming file 110, and update the job ticket with data form the work environment such as, for example, the work flow 150. Finally, the file manager 140 may also store the updated path to the content file in a memory for each incoming file 110, and then submit the updated job ticket to the work flow 150.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method of managing incoming files in a work environment, comprising:
receiving at least one incoming file;
extracting and storing in memory at least one of a ticket and a content file from the incoming file;
reading the ticket extracted from the incoming file;
updating a path to the content file on the basis of the read ticket;
updating the ticket with data form the work environment;
storing the updated path to the content file in a memory; and
submitting the updated ticket to a work flow.

2. The method of claim 1, wherein the ticket comprises a Job Definition Format.

3. The method of claim 1, wherein the content file comprises a Page Definition Format file.

4. The method of claim 1, wherein the incoming file comprises at least one of a MIME file, a zip file and a file created by a user.

5. The method of claim 1, wherein at least one of receiving the incoming file, extracting the ticket and the production content file, reading the ticket, updating the path to the production content file, updating the ticket, storing the updated path to the production content file, the production content file and the ticket in a memory, and submitting the extracted ticket to a work flow require user interaction.

6. The method of claim 1, wherein at least one of receiving the incoming file, extracting the ticket and the production content file, reading the ticket, updating the path to the production content file, updating the ticket, storing the updated path to the production content file, the production content file and the ticket in a memory, and submitting the extracted ticket to a work flow are performed automatically.

7. The method of claim 1, wherein updating the ticket comprises updating production file references based on a memory location of the content file and on information from the work environment.

8. The method of claim 1, wherein the work environment comprises a print shop.

9. The method of claim 5, wherein the user interaction takes place via a context menu to perform specific actions on the incoming file.

10. The method of claim 1, wherein the at least one incoming file is stored in an archive memory before the at least one of the ticket and the content file are extracted.

11. The method of claim 1, wherein receiving the incoming file comprises receiving the incoming file via at least one of a protocol, a server, email and FTP.

12. A system for managing incoming files in a work environment, comprising:
means for receiving at least one incoming file;
means for extracting and storing in memory at least one of a ticket and a content file from the incoming file;
means for reading the ticket extracted from the incoming file;
means for updating a path to the content file on the basis of the read ticket;
means for updating the ticket with data form the work environment;
means for storing the updated path to the content file in a memory; and
means for submitting the updated ticket to a work flow.

13. The system of claim 12, wherein the ticket comprises a Job Definition Format.

14. The system of claim 12, wherein the content file comprises a Page Definition Format file.

15. The system of claim 12, wherein the incoming file comprises at least one of a MIME file, a zip file and a file created by a user.

16. The system of claim 12, wherein the work environment comprises a print shop.

17. The system of claim 12 comprising a context menu to be used by a user.

18. The system of claim 12 comprising at least one of a protocol, a server, email and FTP.

19. The system of claim 12, wherein a controller controls at least one of receiving at least one incoming file, extracting and storing in memory at least one of a ticket and a content file from the incoming file, reading the ticket extracted from the incoming file, updating a path to the content file on the basis of the read ticket, updating the ticket with data form the work environment, storing the updated path to the content file in a memory, and submitting the updated ticket to a work flow.

20. A xerographic device including the system of claim 12.
